(19) United States
(12) Patent Application Publication
(10) Pub. No.: US 2008/0045592 A1
(43) Pub. Date: Feb. 21, 2008

(54) Method of inhibiting growth and proliferation of listeria monocytogenes using levulinate

(75) Inventors: Jeff R. Broadbent, Amalga, UT (US); Charles E. Carpenter, Wellsville, UT (US)

Correspondence Address: UTAH STATE UNIVERSITY;TECHNOLOGY COMMERCIALIZATION OFFICE, 570 RESEARCH PARK WAY, SUITE 101, NORTH LOGAN, UT, 84341, US

(73) Assignee: Utah State University

(21) Appl. No.: 11/894,518

(22) Filed: Aug. 21, 2007

Related U.S. Application Data
(60) Provisional application No. 60/839,269, filed on Aug. 21, 2006.

(51) Int. Cl. A01N 37/02; A01P 1/00; A23L 3/34

(52) U.S. Cl. 514/546; 426/532

(57) ABSTRACT

Methods, formulations and kits containing levulinate or levulinic acid are disclosed that have potent and unexpected properties to inhibit the growth and/or proliferation of Listeria monocytogenes bacteria in a food sample.

### RELATED APPLICATIONS

This application claims the benefit of U.S. Provisional Application No. 60/839,269, filed Aug. 21, 2006, and entitled, “Method of Inhibiting Growth and Proliferation of Listeria monocytogenes Using Levulinate” which is incorporated by reference in its entirety herein.

### FIELD OF THE INVENTION

The present invention relates generally to anti-bacterial methods, materials and apparatus, and more particularly to inhibiting the growth and proliferation of Listeria monocytogenes, Escherichia coli O157:H7, and Salmonella typhimuriu.

### BACKGROUND

Microbial growth and proliferation significantly affects the quality and safety of food, particularly prepared, processed and ready-to-eat meats. Various organic acids and their salts are known preservatives for addition to meat products, most commonly lactic and acetic acid (Shellef (1994) J. Food Prot. 54(4): 282-287; Ricke (2003) Poultry Sci. 82: 632-639). Levulinic acid (4-oxopentanoic acid, C₅H₈O₃) is a commercially available 5-carbon organic acid that has GRAS (Generally Recognized as Safe) status for direct addition to food as a flavoring agent or adjunct (21 CFR, 172.515). Calcium levulinate (the calcium salt of levulinic acid) is also commercially available, and is frequently employed as a source of calcium in nutritional supplements. Levulinate may have activity as a general preservative similar to the salts of other short chain organic acids as suggested by Vasavada et al. (2003) J. Muscle Foods 14: 119-129; and Ghorpade et al, U.S. Patent Application 20050244555, filed Apr. 29, 2004. However, pathogenic bacteria, and especially Listeria monocytogenes strains, are commonly resistant to food preservatives, sanitizers, and even antibiotics (Bonnet et al. (2006) Appl. Environ. Microbiol. 72:2556-2263; Folsom and Frank (2006) J. Food Prot. 69:1292-1296; Romanova et al. (2006) Appl. Environ. Microbiol. 72:3498-3503; Shen et al. (2006) Appl. Environ. Microbiol. 72:5073-5076). For those reasons, Listeria monocytogenes must be used to validate antimicrobial activity under the U.S. Department of Agriculture's directive to reduce L. monocytogenes in ready-to eat meat and poultry products (9 CFR Part 430).

Levulinate has not been specifically suggested or demonstrated to have antimicrobial activity against L. monocytogenes, or any other pathogenic bacteria. There is nothing to suggest or document that levulinate would necessarily have antimicrobial action against pathogenic bacteria, especially against the broad spectrum of L. monocytogenes strains and serovars that are known to be potential health problems when present in meat and other foods. Most specifically, there is no prior suggestion or documentation that levulinate is an effective antimicrobial against L. monocytogenes, and could therefore be used under such regulations as the U.S. Department of Agriculture's directive to reduce L. monocytogenes in ready-to-eat meat and poultry products (9 CFR Part 430). Because levulinic acid is a GRAS flavor adjunct, the unexpected demonstration that levulinic acid is an anti-Listeria agent would be important to improving food safety.

### SUMMARY OF THE INVENTION

The present invention relates to a method for inhibiting the growth and/or proliferation of Listeria monocytogenes in a food sample, preferably a meat sample, in contact with an anti-Listeria effective amount of levulinate.

Another embodiment of the present invention is a formulation of levulinate salts and/or levulinic acid, combined with various ingredients to extend shelf life, stability and application of the levulinate.

Another embodiment of the present invention is a kit for application or contact of levulinate with food samples. Such a kit could include levulinate, or formulations of levulinate, with one or more of an applicator and instructions for application. Such kit could also include levulinate, or formulations or levulinate, pre-coated or pre-incorporated into wrapping, packaging, or casings.

### DESCRIPTION OF THE FIGURES

FIG. 1A shows the growth of L. monocytogenes on a fresh (not cured) ready-to-eat turkey product that was vacuum packaged and stored at 2° C., wherein the open circles are control product, filled circles are product containing 1% sodium levulinate, filled squares are product containing 2% sodium levulinate, and filled diamonds are product containing 3% sodium levulinate. Bars reflect plus and minus the standard errors of the means.

FIG. 1B shows the growth of L. monocytogenes on a fresh (not cured) ready-to-eat turkey product that was vacuum packaged and stored at 2° C., including a comparison to sodium lactate and sodium lactate plus sodium diacetate, wherein the open circles are control product, open squares are 2% sodium lactate, open diamonds are 2% sodium lactate plus diacetate, filled squares are 2% sodium levulinate and filled diamonds are 3% sodium levulinate. Bars reflect plus and minus the standard errors of the means.

FIG. 2A shows the growth of Listeria monocytogenes on a cured ready-to-eat bologna product that was vacuum packaged and stored at 2° C. wherein the open circles are control product, filled circles are product containing 1% sodium levulinate, filled squares are product containing 2% sodium levulinate, and filled diamonds are product containing 3% sodium levulinate. Bars reflect plus and minus the standard errors of the means.

FIG. 2B shows the growth of Listeria monocytogenes on a cured ready-to-eat bologna product that was vacuum packaged and stored at 2° C., including a comparison to sodium lactate and sodium lactate plus sodium diacetate, wherein the open circles are control product, open squares are 2% sodium lactate, open diamonds are 2% sodium lactate plus diacetate, filled circles are 1% sodium levulinate and filled squares are 2% sodium levulinate. Bars reflect plus and minus the standard errors of the means.

### DETAILED DESCRIPTION OF THE INVENTION

The present invention relates to a method for inhibiting the growth and/or proliferation of L. monocytogenes in a food sample contacted with an anti-Listeria effective amount of levulinate. Preferably, the present invention relates to a method for inhibiting the growth and/or proliferation of L. monocytogenes in a ready-to-eat meat containing an anti-Listeria effective amount of levulinate.

The food sample can be any food with a moisture content making it susceptible to growth of bacteria including Listeria. Preferred foods include ready-to-eat foods, deli products, fruits, vegetables and meat. More preferred foods are deli items, including, but not limited to salads, side dishes, desserts and sauces. Also more preferred are ready-to-eat foods, including, but not limited to prepared meals that are prepared on the premises of grocery stores, delis, cafeterias or any other venue other than semi-sterile conditions present at a food processing and packaging facility. These would include take home meals from grocery stores and delis, Meals on Wheels and the like. The most preferred food sample is a meat sample.

A meat sample of the present invention can be any meat product including carcasses, fresh meat, frozen meat, prepared meat, processed meat, ready-to-eat meat, meat-containing products or meat byproducts. The meat can be from any animal, preferably warm blooded animals, preferably birds or farm mammals, most preferably chickens, turkeys, beef, pork and lamb. The method of the invention is most useful for production of prepared, processed or ready-to-eat meat products under the U.S. Department of Agriculture's directive to reduce L. monocytogenes in ready-to eat meat and poultry products (9 CFR Part 430).

The food or meat sample is placed in contact with levulinate, levulinic acid, or combinations of levulinate and levulinic acid sufficient to provide significant inhibition of proliferation of Listeria bacteria. A significant inhibition of proliferation is inhibition greater than the statistical margin of error for measuring the level of Listeria bacterial infection of a food or meat sample. In the present invention, such inhibition is at least 10 percent, preferably 50 percent, more preferably at least 75 percent and most preferably 90 percent or more of what the proliferation would have been in a control food or meat sample not in contact with levulinate. Inhibition of proliferation of Listeria in contact with levulinate is the measurement of inhibition during a time period during which Listeria grows in the untreated product, typically a time period of from about 1 hour to 12 weeks or more, reflecting the expected shelf life of many food or meat products.

In the present invention, reduction of Listeria growth, or inhibition of proliferation, is intended to include each integer from 10 to 99 percent, and each time period from 1 hour to 12 weeks or more. To have inhibitory effects against Listeria, levulinate is typically applied to a meat sample in an amount of 0.1 to 10 percent by weight, preferably 1 to 5 percent by weight, more preferably 1.5 to 2.5 percent by weight, most preferable about 2.5 percent by weight. In the present invention, the percentage of levulinate by weight that is preferred to be contacted with the food or meat sample is intended to include each 0.1 increment from 0.1 to 10 percent.

Listeria that are included in the term anti-Listeria include any bacteria from the genus Listeria, preferably the species Listeria monocytogenes. Preferably, the invention will be effective against a broad spectrum of L. monocytogenes strains that are known to cause food borne infections in humans, such as strains archived in the International Life Sciences Institute (ILSI) Listeria monocytogenes strains collection housed at Cornell University (http://www.foodscience.cornell.edu/weidmand/listeriadbase.htm): FSL J1-177, ribotype DUP-1051D, lineage I, serotype 1/2b, isolated from human sporadic case; FSL C1-056, ribotype DUP-1030A, lineage II, serotype 1/2a, isolated from human sporadic case; FSL N3-013, ribotype DUP-1042B, lineage I, serotype 4b, food isolate associated with human listeriosis epidemic in the UK (1988-1990); FSL R2-499, ribotype DUP-1053A, lineage II, serotype 1/2a, human isolate associated with US outbreak linked to sliced turkey (2000); and FLS N1-227, ribotype DUP-1044A, lineage I, serotype 4b, food isolate associated with US outbreak (1998-1999).

Levulinate used in the present invention is intended to include levulinic acid and alkali salts of levulinic acid, salt solutions of levulinic acid and combinations thereof. Levulinic acid is the preferred form for topical decontamination of food. Alkali salt solutions of levulinic acid (such as sodium levulinate, potassium levulinate, and calcium levulinate) are the preferred form for addition to a food sample. The levulinate is contacted with the food or meat sample so that any Listeria bacteria that are, or become, associated with the food or meat will also be exposed to the levulinate. Contact of the levulinate with the food or meat sample can be by application of levulinate to surfaces of the food or meat sample, or by incorporating levulinate into the meat sample. Application of levulinate to food or meat surfaces can be accomplished by known methods, including mixing, spraying (such as an aerosol, vegetable mister or sprinkler), dips, vapor, marination, and injection or use of an apparatus such as Hansen and Watts, U.S. Pat. No. 6,763,760. Contact of the levulinate with the food or meat sample can be via direct incorporation or application to food or meat. Alternatively, contact of levulinate can be achieved via indirect means such as application or incorporation of levulinate to packaging materials or casings. Packaging materials can include known materials including plastic wraps and storage bags (such as polyethylene (PE), polyvinylidene chloride (PVCD), and polyvinyl chloride (PVC)), meat wrapping paper, freezer paper, parchment paper, wax paper, delicatessen paper, glassine, and nylon. Casings can include natural, collagen and synthetic casings. Levulinic acid is the preferred choice for topical application where its acidity is less likely to be a detriment to product quality, but may provide for an initial reduction in bacterial pathogens. The sodium, potassium, and calcium salts of levulinic acid are the preferred choices for incorporation.

The present invention also includes formulations of levulinate salts and levulinic acid. Such formulations are combinations of levulinate salts or levulinic acid with other ingredients that might contribute to the stability of the levulinate, ease of application to a food or meat sample, and uniformity of the amount of active ingredient levulinate that is applied to the food or meat sample. Such other ingredients can include buffers, clumping inhibitors, dessicants, encapsulants, and surfactants.

The levulinate and/or formulations thereof can be incorporated into a kit for application or contact of levulinate with food, meat or carcasses. Such a kit could include levulinate or formulations of levulinate with one or more of an applicator and instructions for application.

The levulinate and/or formulations thereof can be incorporated into a kit for packaging or wrapping of food, meat or carcasses allowing direct migration of levulinate. Such a kit could include levulinate or formulations of levulinate with instructions for packaging.

The methods and formulations of the present invention are useful to improve the safety of food, particularly meat, by inhibiting proliferation of L. monocytogenes bacteria in meat and preventing serious human food borne illness from infection by L. monocytogenes bacteria. This invention is intended to cover all uses of levulinate as an anti-Listeria agent in food or meat, including, but not limited to, use of levulinate following U.S. Department of Agriculture's directives for reduction of L. monocytogenes in ready-to eat meat and poultry products (9 CFR Part 430). Anticipated variations of this invention include, but are not limited to: the use of levulinc acid for surface decontamination of carcasses and fresh meat under the U.S. Department of Agriculture directive for pathogen reduction and hazard analysis and critical control point systems (9 CRF Parts 304, 308, 310, 320, 327, 381, 416, and 417); the use of levulinate as an anti-Listeria agent in dairy products and other ready-to-eat foods; and, the use of levulinate as an anti-Listeria additive different from its current status as GRAS flavoring agent or adjunct (21 CFR, 172.515).

### EXAMPLES

The embodiments and aspects of the invention described in the specification including the Examples that follow are illustrative of the invention and are not intended to be limiting in any way. Those in the art will appreciate the variations of this invention that are included within the scope of the present invention such as use of levulinate and levulinc acid to inhibit growth of L. monocytogenes and other bacterial pathogens in any food capable of supporting bacterial growth.

### Example 1

### Anti-Listeria Activity of Levulinate Added to Fresh Ready-to-Eat Meat

The following virulent strains of Listeria monocytogenes were obtained from International Life Sciences Institute (ILSI) collection housed at Cornell University (http://www.foodscience.cornell.edu/weidmand/listeriadbase.htm):
FSL J1-177; ribotype DUP-1051D; lineage I; serotype 1/2b; isolated from human sporadic case.
FSL C1-056; ribotype DUP-1030A; lineage II; serotype 1/2a; isolated from human sporadic case.
FSL N3-013; ribotype DUP-1042B; lineage I; serotype 4b; food isolate associated with human listeriosis epidemic in the UK (1988-1990)
FSL R2-499; ribotype DUP-1053A; lineage II; serotype 1/2a; human isolate associated with US outbreak linked to sliced turkey (2000).
FLS N1-227; ribotype DUP-1044A; lineage I; serotype 4b; food isolate associated with US outbreak (1998-1999).

We completed two 12-week challenge trials in a ready-to-eat product made from turkey breast. Product was formulated, and sodium levulinate was contacted with the meat by direct addition and hand mixing of a 30% sodium levulinate solution sufficient to obtain final concentrations (v/wt of meat) of 1%, 2%, and 3% sodium levulinate. Product was stuffed into plastic casings and fully cooked to 71° C., and the final product was sliced. Sample slices were inoculated with the 5 strain cocktail of L. monocytogenes, vacuum packaged, and stored at 2° C. for up to 12 weeks. Samples were collected biweekly and analyzed for growth of L. monocytogenes using BioRad Rapid L'mono.

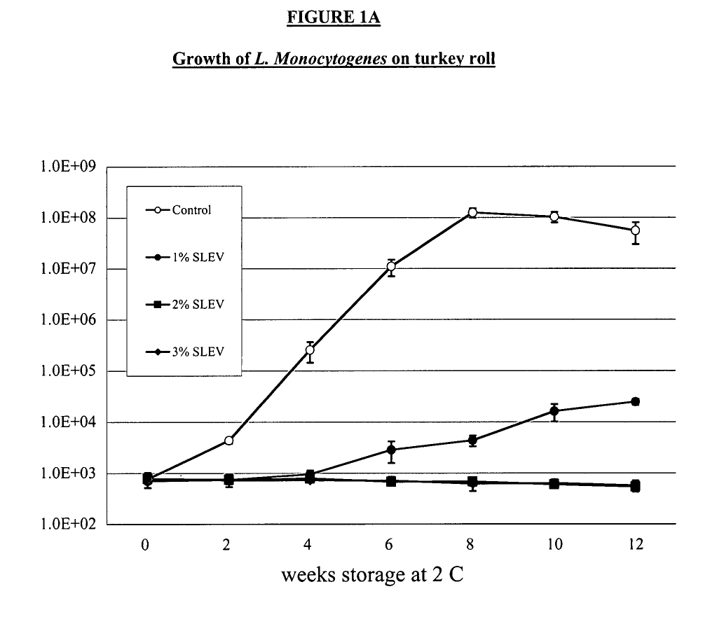

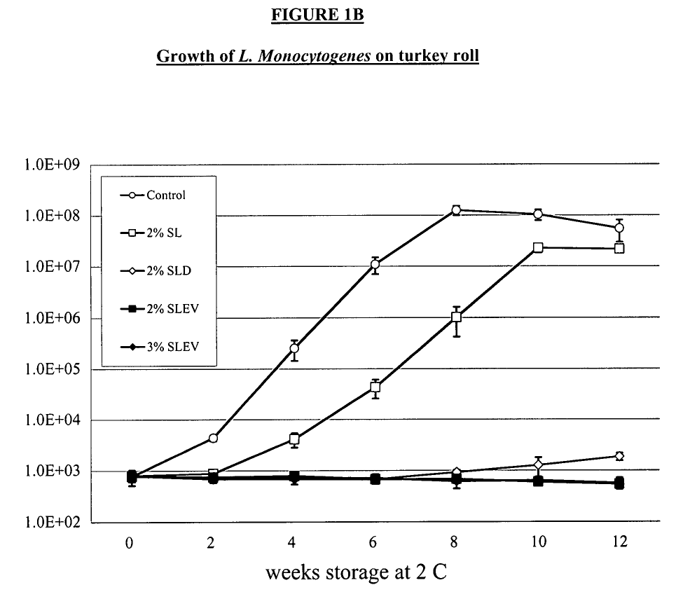

The averaged results from two separate trials of this experiment are shown in FIG. 1A. Counts of L. monocytogenes recovered from untreated control turkey product showed significant growth from the innoculated level after only 2 weeks of storage at 2° C., and growth peaked at more than 10⁸ cfu/cm² after 8 weeks storage. As compared to the control, addition of 1% to levulinate delayed growth of L. monocytogenes, and greatly inhibited peak levels of growth after 12 weeks of storage. Addition of 2% or 3% sodium levulinate to the turkey product completely inhibited growth of L. monocytogenes for the entire 12 weeks of storage.

The same experiment was conducted with additional comparisons to the growth of L. monocytogenes on product that contained sodium lactate and sodium lactate plus sodium diacetate, and results are shown in FIG. 1B. The sodium lactate alone was mixed to a final concentration of 2%. The sodium lactate plus sodium diacetate together was mixed to a final concentration of about 2% volume to weight combined (1.875% sodium lactate and 0.125% sodium diacetate). The averaged results from two trials of this experiment are shown in FIG. 1B. Sodium levulinate used at 2 and 3% was more effective at inhibiting growth of L. monocytogenes than sodium lactate alone or sodium lactate combined with sodium diacetate.

### Example 2

### Anti-Listeria Activity of Levulinate Added to Cured Ready-to-Eat Meat

We completed two separate 12-week challenge trials in a cured ready-to-eat bologna made from pork. Product was formulated, and a volume of 60% sodium levulinate syrup was contacted with the meat by direct addition and bowl chopping of a 30% sodium levulinate solution sufficient to obtain final concentrations (v/wt of meat) of 1%, 2%, and 3% sodium levulinate. Product was stuffed into casings and fully cooked to 71° C., and the final product was sliced. Sample slices were then inoculated with the 5 strain cocktail of L. monocytogenes (described in Example 1), vacuum packaged, and stored at 2° C. for up to 12 weeks. Samples were collected biweekly and analyzed for growth of L. monocytogenes using BioRad Rapid L'mono.

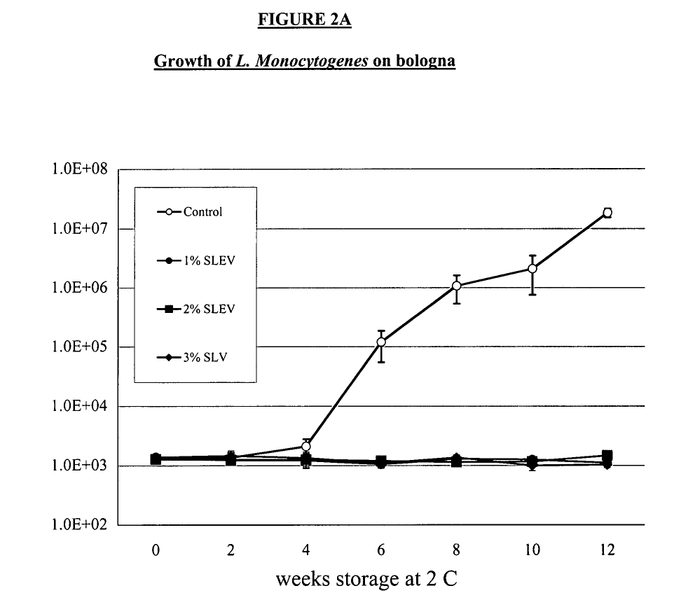

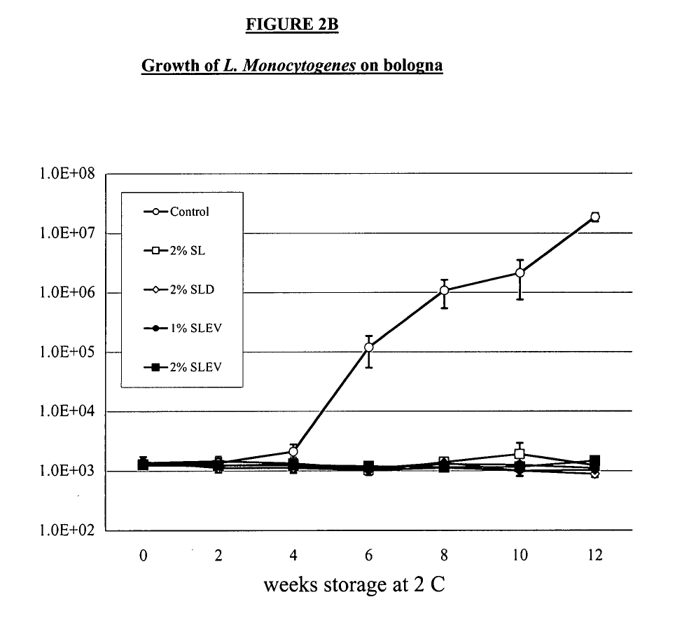

The results from this experiment are shown in FIG. 2A. Counts of L. monocytogenes recovered from untreated control bologna showed significant growth from the inoculated level after 6 weeks of storage at 2° C., and growth reached at 10⁷ cfu/cm² after 12 weeks. Addition of 1, 2 and 3% sodium levulinate to the bologna completely inhibited growth of L. monocytogenes for the entire 12 weeks of storage.

The same experiment was conducted with additional comparisons to the growth of L. monocytogenes on product that contained sodium lactate and sodium lactate plus sodium diacetate. The sodium lactate alone was mixed to a final concentration of 2%. The sodium lactate plus sodium diacetate together was mixed to a final concentration of about 2% volume to weight combined (1.875% sodium lactate and 0.125% sodium diacetate). The averaged results from the two trials of this experiment are shown in FIG. 2B. Sodium levulinate at 1, 2 or 3% was as inhibitory to growth of L. monocytogenes as sodium lactate alone or sodium lactate combined with sodium diacetate.

### Example 3

### Effect of Sodium Levulinate on Taste Sensation in a Taste Panel

A sensory panel consisting of anonymous consumers rated samples of turkey breast roll and bologna for their overall liking of the products. Samples were scored on a scale of 1 to 9, with 1=strongly dislike, 5=neither like nor dislike, and 9=strongly like. In the turkey roll panel, judges were given samples containing no antimicrobial (control), 2% sodium lactate, 2% sodium lactate plus sodium diacetate, 2% sodium levulinate, and 3% sodium levulinate. In the bologna analysis, the consumers were given samples containing no antimicrobial (control), 2% sodium lactate, the 2% combination of sodium lactate and sodium diacetate, 1% sodium levulinate and 2% sodium levulinate. There were 132 consumers that participated in the sensory panel for the turkey roll and 112 for the bologna. Of those who participated in the turkey roll panel, 66 were female and 66 were male. There was a wide range of age among the participants, with the majority being in the 18 to 25 age group. Similar demographic data was found among the participants of the bologna sensory panel. There were 58 females and 54 males, most of who were in the age group 18 to 25.

Results of the sensory studies are given in Table 1. There were no differences in overall liking among the preparations of turkey roll or bologna indicating that addition of sodium levulinate did not negatively impact the sensory quality of the products.

TABLE 1
Mean scores for overall liking of turkey breast roll and bologna.

| | | | Sodium | | | | |
|---|---|---|---|---|---|---|---|
| | | | Lactate | 1% | 2% | 3% | |
| | | 2% Sodium | plus | Sodium | Sodium | Sodium | p- |
| | Control | Lactate | Diacetate | Levulinate | Levulinate | Levulinate | Value |
| Turkey | 6.8 | 6.9 | 6.8 | NA | 6.6 | 6.6 | 0.19 |
| Bologna | 6.2 | 6.2 | 6.2 | 6.0 | 6.0 | NA | 0.42 |

### Example 4

### Anti-Listeria Activity of Levulinate Acid Topically Applied to Prepared Meat

This experiment tests the residual anti-Listeria activity imparted by topical application of levulinate to ready-to-eat meat product. In this experiment, levulinic acid is topically applied to a ready-to-eat meat product, and residual anti-Listeria activity followed in a post-treatment challenge. Briefly, bologna slices are surface contacted (spray, wash, or dips) with solutions of 1 to 3% levulinic acetic acid. The slices are inoculated with a cocktail of 5 pathogenic strains of L. monocytogenes. Samples are vacuum packaged and stored at 4° C. for 16 weeks. Pathogen counts are determined at 0, 2, 4, 8, 12 and 16 weeks.

The results show a significant decrease in the proliferation of Listeria bacteria in meat samples that have been treated (contacted) with levulinic acid.

### Example 5

### Pathogen Decontamination by Levulinic Acid Topically Applied to Meat Carcass Tissue as Compared to Lactic Acid and Acetic Acid

This experiment tests the extent of decontamination achieved by topical application of levulinic acid to carcass meats as compared to lactic and acetic acids. Briefly, carcass tissues samples from beef, pork, lamb, and poultry (or any other species) are inoculated with pathogenic bacteria including, but not limited to, Listeria monocytogenes. Levulinic acid (2%), lactic acid (2%), and acetic acid (2%) are independently applied at 54° C. to individual meat samples by washing, dipping, or spraying. Samples are vacuum packaged and stored at 4° C. for 12 hours, and pathogen counts are determined.

The results show that addition or application of levulinic acid to meat products provides an equal or greater decontamination of pathogens as compared to lactic acid and acetic acid.

### Example 6

### Residual Anti-Pathogenic Activity of Levulinic Acid Topically Applied to Carcass Tissues as Compared to Lactic Acid and Acetic Acid

This experiment tests the extent of residual anti-pathogenic activity of levulinic acid (2%) topically applied to carcasses by dipping, spraying, or washing as compared to lactic acid (2%) or acetic acid (2%). Briefly, levulinic acid, lactic acid and acetic acid are independently applied at 54° C. to samples of carcass tissues from beef, pork, lamb, and poultry (or any other species) by topical application. Samples are inoculated with pathogenic bacteria (including, but not limited to Listeria monocytogenes), vacuum packaged, and stored (4 to 8° C.) for 16 weeks. Pathogen counts are determined at 0, 2, 4, 8, 12, and 16 weeks.

The results show that addition or application of levulinic acid to meat products provides an equal or greater residual anti-pathogenic activity as compared to lactic acid and acetic acid.

### Example 7

### Pathogen Decontamination by Temperature-Specific and Concentration-Specific Levulinic Acid Topically Applied to Meat Products

This experiment tests the use of elevated temperatures in combination with topical application of varying concentrations of levulinic acid as compared to standard temperature and concentrations of lactic acid and acetic acid. Briefly, sample meat products are inoculated with pathogenic bacteria (including, but not limited to, Listeria monocytogenes). Levulinic acid solutions (0, 0.5, 1.0, and 2.0% levulinic acid) are topically applied at 54, 68, and 77° C. to the surfaces of inoculated meat products by washing, dipping, or spraying. In parallel, lactic acid and acetic acid solutions (2% fixed concentration) are topically applied at fixed temperature of 54° C. to the surfaces of inoculated meat products by washing, dipping, or spraying. Samples are vacuum packaged and stored at 4° C. for 12 hours, and pathogen counts are determined.

The results show that addition or application of concentration-specific levulinic acid at temperatures greater than 54° C. to meat products provides significant initial surface decontamination activity against pathogenic bacteria as compared to fixed concentrations of lactic acid or acetic acid at a fixed temperature.

### Example 8

### Anti-Pathogenic Activity of Levulinate and Levulinic Acid Applied or Added to Foods

This experiment tests the extent of decontamination and residual anti-pathogenic activity imparted by addition or topical application of levulinic acid and levulinate to fresh, processed, and ready-to-eat foods. Briefly, a sample of food is challenged with an inoculation of pathogenic bacteria (including, but not limited to, Listeria monocytogene) before or after treatment of the food with levulinic acid or levulinate. Treatment with levulinate and levulinic acid is by addition or application of levulinc acid or levulinate in any of its physical (solid, liquid, or vapor) or chemical (acid, salt, or other derivative). Challenged samples are packaged and stored at 4 to 8° C. for up to 16 weeks. Pathogen counts are determined at 0, 2, 4, 8, 12, and 16 weeks.

The results show that addition or application of levulinic acid or levulinate to any food provides significant initial decontamination and residual activity against pathogenic bacteria.

### Example 9

### Effect of Levulinic Acid on Taste Sensation in a Taste Panel

This experiment will evaluate whether topical application of levulinate to raw meats impacts the sensory quality of the final products. Ground beef trimmings and turkey breast will be washed with water, 2% lactic acid, 2% acetic acid, or 2% levulinic acid at 54° C. These raw materials will be made into cooked ground beef patties and turkey roll, respectively. A sensory panel consisting of anonymous consumers will rate cooked ground beef and ready to eat sliced turkey roll samples for their overall liking of the products. Samples are scored on a scale of 1 to 9, with 1=strongly dislike, 5=neither like nor dislike, and 9=strongly like.

Results show that topical application of levulinate to raw meats does not negatively impact the sensory quality of the final products.

What is claimed is:

1. A method for inhibiting the growth and/or proliferation of a bacteria in a food sample comprising;
contacting the food sample with an anti-bacterial effective amount of levulinate.

2. The method of claim 1, wherein;
the bacteria is selected from the group consisting of Listeria monocytogenes,
Escherichia coli O157:H7, and Salmonella typhimuriu.

3. The method of claim 2, where the bacteria is Listeria monocytogenes.

4. The method according to claim 3, wherein;
the anti-Listeria effective amount of levulinate is from about 0.1 to about 10 percent of the weight of the food sample by weight.

5. The method according to claim 3, wherein;
the anti-Listeria effective amount of levulinate is from about 1 to about 5 percent of the weight of the food sample by weight.

6. The method according to claim 3, wherein;
the anti-Listeria effective amount of levulinate is from about 1.5 to about 2.5 percent of the weight of the food sample by weight.

7. The method according to claim 3, wherein;
the anti-Listeria effective amount of levulinate is about 2.5 percent of the weight of the food sample by weight.

8. The method according to claim 3, wherein;
the contacting of the food sample is selected from the group consisting of mixing, spraying (such as an aerosol, vegetable mister or sprinkler), dips, vapor, marination or injection.

9. The method of claim 3, wherein;
the contacting of said food is by use of packaging that has been pre-coated or pre-incorporated with said levulinate.

10. The method of claim 3, wherein;
the contacting of said food is by use of casings that has been pre-coated or pre-incorporated with said levulinate.

11. The method according to claim 3, wherein;
the food sample is selected from the group consisting of ready to eat foods, deli products, fruits, vegetables and meat.

12. The method according to claim 11, where the food sample is a meat sample.

13. The method according to claim 12, wherein;
the meat sample is selected from the group consisting of ready-to-eat meat, processed meat, prepared meat product or meat carcasses.

14. The method according to claim 12, wherein;
the anti-Listeria effective amount of levulinate is from about 0.1 to about 10 percent of the weight of the meat sample by weight.

15. The method according to claim 12, wherein;
the anti-Listeria effective amount of levulinate is from about 1 to about 5 percent of the weight of the meat sample by weight.

16. The method according to claim 12, wherein;
the anti-Listeria effective amount of levulinate is from about 1.5 to about 2.5 percent of the weight of the meat sample by weight.

17. The method according to claim 12, wherein;
the anti-Listeria effective amount of levulinate is about 2.5 percent of the weight of the meat sample by weight.

18. An anti-bacterial formulation comprising; an anti-bacterial effective amount of levulinate.

19. The formulation according to claim 18 wherein; the anti-bacterial formulation is anti-Listeria formulation.

20. The method of claim 18, further comprising;
an ingredient that contributes to the stability of said levulinate.

21. The method of claim 18, further comprising;
an ingredient that contributes to the ease of application of said levulinate.

22. The method of claim 18, further comprising;
an ingredient that contributes to the application uniformity of the amount of said levulinate that is applied.

23. The method of claim 18, further comprising;
an ingredient that is selected from the group consisting of buffers, clumping inhibitors, encapsulants, dessicants or surfactants.

24. The formulation according to claim 19 wherein; the anti-bacterial formulation is for application to food.

25. The formulation according to claim 24 wherein; the food sample is selected from the group consisting of ready to eat foods, deli products, fruits, vegetables and meat.

26. The formulation according to claim 25 where the food sample is a meat sample.

27. The formulation according to claim 26 wherein;
the meat sample is selected from the group consisting of ready-to-eat meat, processed meat, prepared meat product or meat carcasses.

28. The formulation according to claim 26, wherein;
the anti-Listeria effective amount of levulinate is from about 0.1 to about 10 percent of the weight of the meat sample by weight.

29. The formulation according to claim 26, wherein;
the anti-Listeria effective amount of levulinate is from about 1 to about 5 percent of the weight of the meat sample by weight.

30. The formulation according to claim 26, wherein;
the anti-Listeria effective amount of levulinate is from about 1.5 to about 2.5 percent of the weight of the meat sample by weight.

31. The formulation according to claim 26, wherein;
the anti-Listeria effective amount of levulinate is about 2.5 percent of the weight of the meat sample by weight.

32. A kit for inhibiting the growth and/or proliferation of bacteria in a food sample comprising an anti-bacterial effective amount of levulinate.

33. A kit according to claim 26 where the bacteria is Listeria monocytogenes.

34. A kit according to claim 27, further comprising;
one or more items selected from the group consisting of an applicator and instructions for applying an anti-Listeria effective amount of levulinate.
